(19) United States
(12) Patent Application Publication
(10) Pub. No.: US 2026/0014938 A1
(43) Pub. Date: Jan. 15, 2026

(54) FOLDABLE WEATHER MEASUREMENT DEVICE MOUNTED ON A MOVING BODY TO OBSERVE THE WEATHER IN REAL TIME

(71) Applicant: NATIONAL INSTITUTE OF METEOROLOGICAL SCIENCES, Seogwipo-si (KR)

(72) Inventors: Geontae KIM, Gangneung-si (KR); Jinhwa LEE, Gangneung-si (KR); Minjeong KIM, Yongin-si (KR); Byunghwan LIM, Seogwipo-si (KR)

(73) Assignee: NATIONAL INSTITUTE OF METEOROLOGICAL SCIENCES, Seogwipo-si (KR)

(21) Appl. No.: 19/258,546

(22) Filed: Jul. 2, 2025

(30) Foreign Application Priority Data
Jul. 9, 2024 (KR) 10-2024-0090392

(51) Int. Cl. B60R 11/00; F15B 15/14; G01W 1/04; H01Q 1/32

(52) U.S. Cl. CPC B60R 11/00; F15B 15/1447; G01W 1/04; H01Q 1/32; B60R 2011/004; B60R 2011/0082; B60R 2011/0084; B60R 2011/0085; B60R 2011/0092

(57) ABSTRACT

A foldable weather measurement device is provided. The device includes: a frame including: (i) a bottom support whose bottom part is mounted on the moving body, (ii) a top support configured to install meteorological instruments, (iii) a first support column to a fourth support column, each of which has each one end connected to each of a (b_1)-st part to a (b_4)-th part of the bottom support and each opposite end connected to each of a (t_1)-st part to a (t_4)-th part of the top support, and (iv) a first and a second gas shock absorber, each of which has each one end connected to each of the (b_1)-st part and the (b_2)-nd part located in a front direction, and each opposite end connected to each of a (3_1)-st part of the third support column and a (4_1)-st part of the fourth support column located at a rear direction.

### CROSS REFERENCE OF RELATED APPLICATION

This present application claims the benefit of the earlier filing date of Korean non-provisional patent application No. 10-2024-0090392, filed on Jul. 9, 2024, the entire contents of which being incorporated herein by reference.

### FIELD OF THE DISCLOSURE

The present disclosure relates to a foldable weather measurement device mounted on a moving body to observe weather in real time. To be specific, the present disclosure relates to a foldable weather measurement device which can accurately observe the weather in real time by adjusting a frame automatically to maintain a suitable observation condition for meteorological instruments depending on weather conditions and driving environments of a vehicle, etc., while being mounted on the moving body.

### BACKGROUND OF THE DISCLOSURE

Recently, in order to observe meteorological phenomenon occurring locally and for a short period of time, a method of observation by driving a moving body such as automobiles, ships, drones, airplanes, etc. quickly to an area where the meteorological phenomenon occurs, with a frame mounted on the moving body after installing meteorological instruments such as an anemometer, a barometer, a thermometer, a hygrometer, etc. on the frame is used.

In this case, a suitable observation condition (hereinafter, an observation condition) should be maintained appropriately for each of the meteorological instruments while observing the weather. For example, according to a ground-based meteorological observation guideline published by the Korea Meteorological Administration, the anemometer should not be affected by wind occurred by another object. Regarding this, by referring to FIG. 1, when a vehicle as the moving body is driving, wind (such as vortex) toward the vehicle is blowing over the vehicle and thus, the anemometer should be installed at a position (e.g., a high position) outside from a wind path. An accurate observation of the weather cannot be achieved without meeting such installation standards.

There has been attempts to observe weather by installing the meteorological instruments on the frame and mounting the frame on the moving body. However, when a height of the frame or a height of a meteorological instrument installed on a top part of the frame from the ground while driving of the moving body is higher than a height of a limited height structure such as a road sign, a tunnel, an indoor parking lot, the frame or the meteorological instrument installed on the frame may be broken, and such examples are shown in FIGS. 2A and 2B. As an example, FIG. 2A is an example of a broken anemometer installed on the top part of the frame due to the limited height structure, and FIG. 2B is an example of a broken frame due to the limited height structure.

On the other hand, in case of lowering the installation position of the meteorological instrument in order to prevent such breakage, it is difficult to measure accurately since the suitable observation condition cannot be maintained due to the effect of wind, etc. as explained by referring to FIG. 1 above, and also, the observation condition may not be maintained due to pollutants such as exhaust gases from the moving body.

Thus, there is a need to solve above problems.

### SUMMARY OF THE DISCLOSURE

It is an object of the present disclosure to solve all of the aforementioned problems.

It is another object of the present disclosure to mount multiple types of meteorological instruments on a moving body without an interference among the multiple types of meteorological instruments, and thus to increase a suitability of observation conditions, thereby allowing accurate observation of weather.

It is still another object of the present disclosure to prevent breakage of the meteorological instruments by operating in a first mode or a second mode according to weather environments or driving environments of the moving body, and to maintain a suitability of the observation conditions for each of the meteorological instruments installed on the frame even during a mode switching process.

In order to achieve the above objects and achieve the desired results that will be introduced hereinafter, the configuration of the present disclosure is as follows:

In accordance to one aspect of the present disclosure, there is provided a foldable weather measurement device mounted on a moving body to observe a weather in real time, comprising: a frame including: (i) a bottom support whose bottom part is mounted on the moving body through a main connector, (ii) a top support configured to install at least one meteorological instrument on at least part of a top surface thereof and a front surface thereof, (iii) a first support column to a fourth support column, each of which has each one end connected to each of a (b_1)-st part to a (b_4)-th part of the bottom support and each opposite end connected to each of a (t_1)-st part to a (t_4)-th part of the top support, and (iv) a first gas shock absorber and a second gas shock absorber, each of which has each one end connected to each of the (b_1)-st part and the (b_2)-nd part which are located in a front direction among the (b_1)-st part to the (b_4)-th part, and each opposite end connected to each of a (3_1)-st part of the third support column and a (4_1)-st part of the fourth support column which are located at a rear direction among the first support column to the fourth support column; wherein the device operates in a first mode or in a second mode, wherein, when (i) the (b_1)-st part and the (b_2)-nd part are located in the front direction among the (b_1)-st part to the (b_4)-th part, (ii) the (b_3)-rd part and the (b_4)-th part are located at the rear direction among the (b_1)-st part to the (b_4)-th part, (iii) the (t_1)-st part and the (t_2)-nd part are located in the front direction among the (t_1)-st part to the (t_4)-th part, and (iv) the (t_3)-rd part and the (t_4)-th part are located at the rear direction among the (t_1)-st part to the (t_4)-th part, a virtual f-th symmetric line which connects a (f_b)-th midpoint of a front bottom outer side surface located in the front direction among the bottom support and a (f_t)-th midpoint between the (t_1)-st part and the (t_2)-nd part is maintained at an (f_1)-st angle from a reference line based on a longitudinal direction of the moving body which passes through the (f_b)-th midpoint, in the first mode, a virtual r-th symmetric line which connects a (r_b)-th midpoint of a rear bottom outer side surface which is located at the rear direction among the bottom support and a (r_t)-th midpoint between the (t_3)-rd part and the (t_4)-th part is maintained at an (r_1)-st angle which is an angle from the reference line based on the longitudinal direction of the moving body which passes through the (r_b)-th midpoint, and in the second mode, the virtual f-th symmetric line which connects the (f_b)-th midpoint of the front bottom outer side surface and the (f_t)-th midpoint is maintained at an (f_2)-nd angle which is an angle from the reference line based on the longitudinal direction of the moving body which passes through the (f_b)-th midpoint, and the virtual r-th symmetric line which connects the (r_b)-th midpoint of the rear bottom outer side surface and the (r_t)-th midpoint is maintained at an (r_2)-nd angle which is an angle from the reference line based on the longitudinal direction of the moving body which passes through the (r_b)-th midpoint, wherein the (f_1)-st angle and the (r_1)-st angle are larger than the (f_2)-nd angle and the (r_2)-nd angle, wherein the device further comprises: an antenna module including at least part of a first antenna and a second antenna to be used for transmitting and receiving of signal with outside, wherein the antenna module is connected to a first sub-connector module formed in a direction perpendicular to a ground at a (b_5)-th part located at the rear direction among the bottom support; and a second sub-connector module including at least part of (i) a (2_1)-st sub-connector whose one end is connected to a (3_2)-nd part of the third support column and whose opposite end is connected to a first side of the first sub-connector module where the first antenna is connected and wherein the (2_1)-st sub-connector moves the first antenna in conjunction with an operation of the first gas shock absorber, and (ii) a (2_2)-nd sub-connector whose one end is connected to a (4_2)-nd part of the fourth support column and whose opposite end is connected to a second side of the first sub-connector module where the second antenna is connected and wherein the (2_2)-nd sub-connector moves the second antenna in conjunction with an operation of the second gas shock absorber.

As one example, each of a (b_1)-st hinge to a (b_4)-th hinge, a (t_1)-st hinge to a (t_4)-th hinge and a (b_5)-th hinge is formed in each of the (b_1)-st part to the (b_4)-th part, the (t_1)-st part to the (t_4)-th part and the (b_5)-th part, wherein each one end of the first support column to the fourth support column is connected to each of the (b_1)-st hinge to the (b_4)-th hinge and each opposite end of the first support column to the fourth support column is connected to each of the (t_1)-st hinge to the (t_4)-th hinge, and wherein the first sub-connector module is connected to the (b_5)-th hinge, and (i) when a first manipulation signal for changing from the first mode to the second mode is obtained, at least part of a first rod of the first gas shock absorber is inserted into a first piston part of the first gas shock absorber, at least part of a second rod of the second gas shock absorber is inserted into a second piston part of the second gas shock absorber, and each of the first support column to the fourth support column rotates towards the front direction of the moving body until each of the first support column to the fourth support column forms the (f_2)-nd angle or the (r_2)-nd angle through the (b_1)-st hinge to the (b_4)-th hinge and the (t_1)-st hinge to the (t_4)-th hinge, and (ii) when a second manipulation signal for changing from the second mode to the first mode is obtained, at least part of the first rod inserted into the inner side of the first piston part protrudes from the first piston part due to an inner pressure thereof, at least part of the second rod inserted into the inner side of the second piston part protrudes from the second piston part due to an inner pressure thereof, and each of the first support column to the fourth support column rotates until each of the first support column to the fourth support column forms the (f_1)-st angle or the (r_1)-st angle through the (b_1)-st hinge to the (b_4)-th hinge and the (t_1)-st hinge to the (t_4)-th hinge.

As one example, (i) in response to a rotation of each of the first support column to the fourth support column towards the front direction of the moving body according to the first manipulation signal, the first sub-connector module rotates towards the front direction of the moving body in conjunction with the second sub-connector module through the (b_5)-th hinge, resulting in a rotation of at least part of the first antenna and the second antenna towards the front direction of the moving body, and (ii) in response to a rotation of each of the first support column to the fourth support column until it forms the (f_1)-st angle or the (r_1)-st angle according to the second manipulation signal, the first sub-connector module rotates in conjunction with the second sub-connector module through the (b_5)-th hinge, resulting in a rotation of at least part of the first antenna and the second antenna.

As one example, the device comprises a (2_1)-st sub-gas shock absorber as the (2_1)-st sub-connector, one end of a (2_1)-st sub-piston part of the (2_1)-st sub-gas shock absorber is connected to the (3_2)-nd part of the third support column, and one end of a (2_1)-st sub-rod of the (2_1)-st sub-gas shock absorber is connected to the first side of the first sub-connector module, and wherein the device comprises a (2_2)-nd sub-gas shock absorber as the (2_2)-nd sub-connector, one end of a (2_2)-nd sub-piston part of the (2_2)-nd sub-gas shock absorber is connected to the (4_2)-nd part of the fourth support column, and one end of a (2_2)-nd sub-rod of the (2_2)-nd sub-gas shock absorber is connected to the second side of the first sub-connector module, and wherein (i) in the first mode, at least part of the (2_1)-st sub-rod is maintained as inserted in the (2_1)-st sub-piston part and at least part of the (2_2)-nd sub-rod is maintained as inserted in the (2_2)-nd sub-piston part, and (ii) in the second mode, at least part of the (2_1)-st sub-rod inserted in the (2_1)-st sub-piston part is maintained as protruded from the (2_1)-st sub-piston part due to an inner pressure of the (2_1)-st sub-piston part, and at least part of the (2_2)-nd sub-rod inserted in the (2_2)-nd sub-piston part is maintained as protruded from the (2_2)-nd sub-piston part due to an inner pressure of the (2_2)-nd sub-piston part.

As one example, the (2_1)-st sub-connector further includes a (2_1)-st sub-spring, and the (2_1)-st sub-spring surrounds at least part of the (2_1)-st sub-piston part and the (2_1)-st sub-rod, and the (2_2)-nd sub-connector further includes a (2_2)-nd sub-spring, and the (2_2)-nd sub-spring surrounds at least part of the (2_2)-nd sub-piston part and the (2_2)-nd sub-rod, and wherein (i) in the first mode, the (2_1)-st sub-spring shrinks due to a pressure applied to the (2_1)-st sub-spring, resulting in an insertion of at least part of the (2_1)-st sub-rod into the (2_1)-st sub-piston part, and the (2_2)-nd sub-spring shrinks due to a pressure applied to the (2_2)-nd sub-spring, resulting in an insertion of at least part of the (2_2)-nd sub-rod into the (2_2)-nd sub-piston part, and (ii) in the second mode, the (2_1)-st sub-spring expands comparing to the (2_1)-st sub-spring at the first mode, resulting in a protrusion of at least part of the (2_1)-st sub-rod inserted in the (2_1)-st sub-piston part, and the (2_2)-nd sub-spring expands comparing to the (2_2)-nd sub-spring at the first mode, resulting in a protrusion of at least part of the (2_2)-nd sub-rod inserted in the (2_2)-nd sub-piston part.

As one example, the device further comprises: a horizontal moving part including (i) a first hollow rod part formed in at least part of the front bottom outer side surface and the rear bottom outer side surface, and (ii) a horizontal moving column capable of being inserted or protruded through the first hollow rod part; a vertical moving part including (i) a second hollow rod part formed at one end of the horizontal moving part, and (ii) a vertical moving column capable of being inserted or protruded through the second hollow rod part; and a shading box directly or indirectly coupled to the vertical moving part.

As one example, the device further comprises: a third gas shock absorber formed in the first hollow rod part; and wherein one end of the third gas shock absorber is connected to the horizontal moving column, and the horizontal moving column moves horizontally in conjunction with an operation of the third gas shock absorber.

As one example, the device further comprises: a fourth gas shock absorber formed in the second hollow rod part; and wherein one end of the fourth gas shock absorber is connected to the vertical moving column, and the vertical moving column moves vertically in conjunction with an operation of the fourth gas shock absorber.

As one example, while maintaining the (f_1)-st angle and the (r_1)-st angle in the first mode, a top surface of the top support is maintained as parallel to the ground, and while maintaining the (f_2)-nd angle and the (r_2)-nd angle in the second mode, the top surface of the top support is maintained as parallel to the ground.

As one example, in the first mode, when a limited height structure with a passage height lower than (i) a summed height of a height of from the ground to a top surface of the top support and a length which is a height of a highest meteorological instrument itself among the at least one meteorological instrument installed on the top surface of the top support or (ii) a spare summed height which is an addition of a spare height to the summed height is detected, the first gas shock absorber and the second gas shock absorber are operated to change from the first mode to the second mode by changing from the (f_1)-st angle and the (r_1)-st angle to the (f_2)-nd angle and the (r_2)-nd angle.

As one example, when it is detected in the second mode that the moving body has passed through a limited height structure with a passage height lower than (i) a summed height of a height of from the ground to a top surface of the top support and a length which is a height of a highest meteorological instrument itself at a time of being operated in the first mode among the at least one meteorological instrument installed on the top surface of the top support or (ii) a spare summed height which is an addition of a spare height to the summed height, and when it is detected that no another limited height structure is within forward threshold distance of the moving body, wherein the another limited height structure has the passage height lower than (i) the summed height of a height from ground to the top surface of the top support and the length which is the height of the highest meteorological instrument itself at a time of being operated in the first mode among the at least one meteorological instrument installed on the top surface of the top support, or (ii) the spare summed height which is an addition of the spare height to the summed height, wherein the another limited height structure is different structure from the limited height structure, the first gas shock absorber and the second gas shock absorber are operated to change to the first mode by changing from the (f_2)-nd angle and the (r_2)-nd angle to the (f_1)-st angle and the (r_1)-st angle.

As one example, the device further comprises: a wind anemometer installed in a front area among the top surface of the top support to measure a direction and a speed of wind in real time.

As one example, the device further comprises: a barometer installed on the front surface the top surface to measure an atmospheric pressure.

### BRIEF DESCRIPTION OF THE DRAWINGS

The above and other objects and features of the present disclosure will become apparent from the following description of preferred embodiments given in conjunction with the accompanying drawings. The accompanying drawings used to explain example embodiments of the present disclosure are only part of example embodiments of the present disclosure and other drawings can be obtained based on the drawings by those skilled in the art of the present disclosure without inventive work.

FIG. 1 is a schematic drawing of an effect of wind generated during a driving of a vehicle.

FIGS. 2A and 2B are schematic drawings for cases of breakage of a conventional frame mounted on a moving body and meteorological instruments installed on the frame.

FIGS. 3A and 3B are schematic drawings of a foldable weather measurement device according to one example embodiment of the present disclosure.

FIGS. 4A and 4B are schematic drawings of rear views of the foldable weather measurement device according to one example embodiment of the present disclosure.

FIG. 5 is a schematic drawing of a configuration for moving a shading box horizontally and vertically in accordance with one example embodiment of the present disclosure.

FIGS. 6A and 6B are schematic drawings of examples of the foldable weather measurement device mounted on the moving body in accordance with one example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention.

It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to carry out the present invention easily, the example embodiments of the present invention by referring to attached diagrams will be explained in detail as shown below.

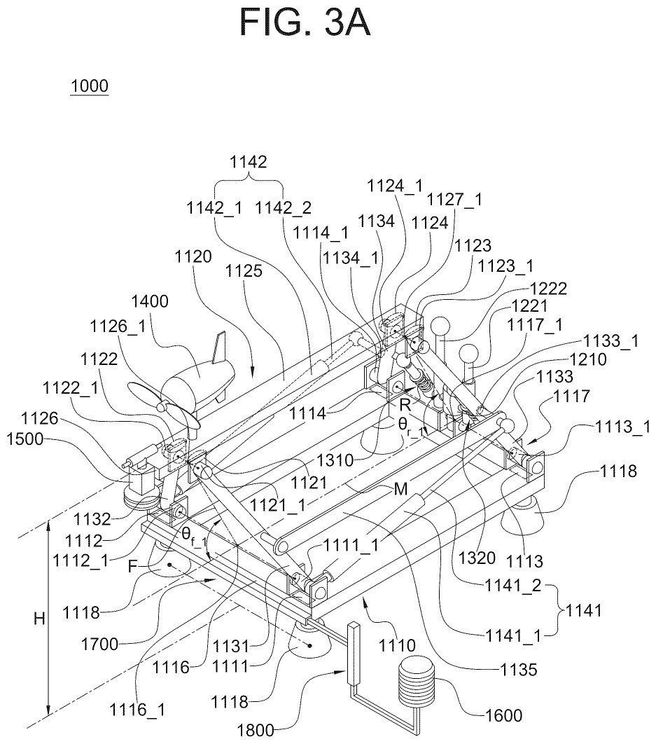

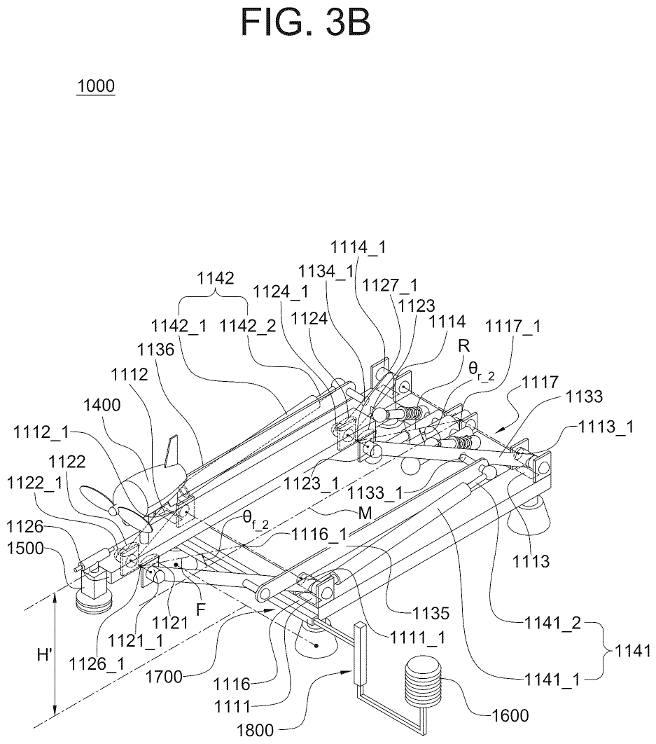

FIG. 3A and FIG. 3B are schematic drawings of a foldable weather measurement device according to one example embodiment of the present disclosure.

To be specific, FIG. 3A illustrates a foldable weather measurement device 1000 operating in a first mode, and FIG. 3B illustrates the foldable weather measurement device 1000 operating in a second mode.

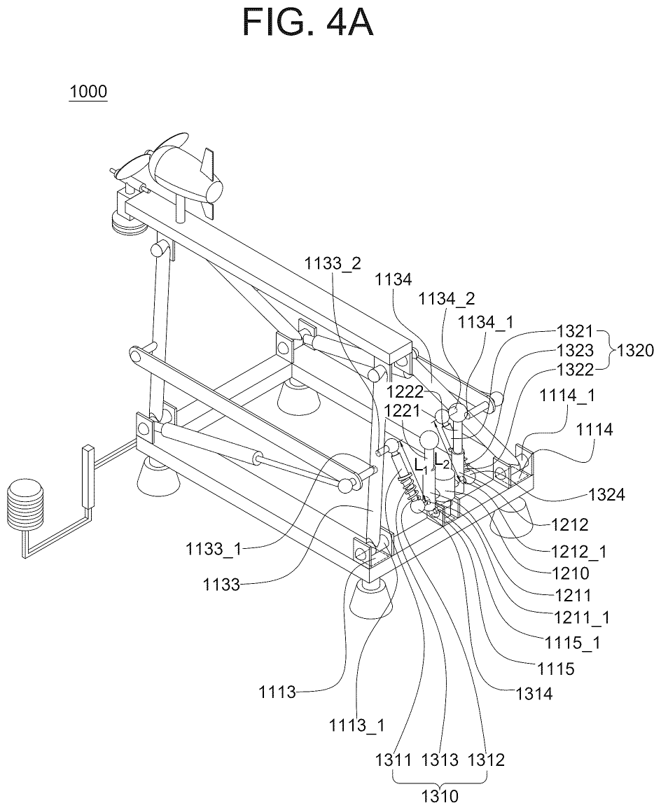

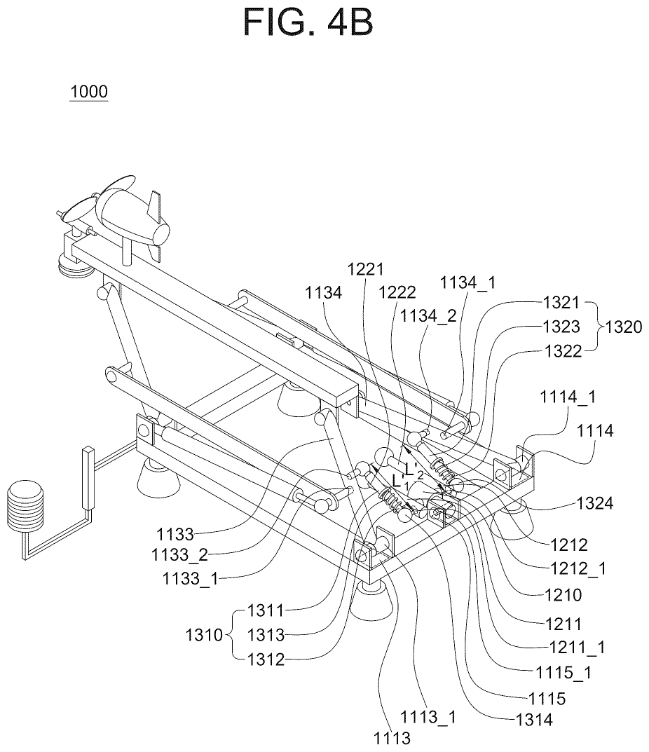

Referring to FIG. 3A and FIG. 3B, the foldable weather measurement device 1000 may include a frame 1100, and may further include an antenna module 1200 and a second sub-connector module 1300. Although reference numbers for each of the frame 1100, the antenna module 1200 and the second sub-connector module 1300 are not indicated in FIG. 3A and FIG. 3B, each of the frame 1100, the antenna module 1200 and the second sub-connector module 1300 may include subcomponents as follows. This can be applied to FIG. 4A and FIG. 4B in a similar way.

(i) The frame 1100 may include a bottom support 1110, a top support 1120, a first support column 1131 to a fourth support column 1134, a first gas shock absorber 1141 and a second gas shock absorber 1142, (ii) the antenna module 1200 may include a first sub-connector module 1210, at least part of a first antenna 1221 and a second antenna 1222, and (iii) the second sub-connector module 1300 may include at least part of a (2_1)-st sub-connector 1310 and a (2_2)-nd sub-connector. Below, the frame 1100 of the foldable weather measurement device 1100 will be explained first, and the antenna module 1200 and the second sub-connector module 1300 which of the foldable weather measurement device 1000 will be explained later by referring to FIG. 4A and FIG. 4B.

Referring to FIG. 3A, the bottom support 1110 of the frame 1100 is a structure for mounting a bottom part thereof on a moving body through a main connector 1118, and each one end of the first support column 1131 to the fourth support column can be connected to each of a (b_1)-st part 1111 to a (b_4)-th part 1114 of the bottom support 1110. Herein, among the (b_1)-st part 1111 to the (b_4)-th part 1114, the (b_1)-st part 1111 and the (b_2)-nd part 1112 may be located at a front direction (that is, front parts of the moving body), and a (b_3)-rd part 1113 and a (b_4)-th part 1114 may be located at a rear direction (that is, rear parts of the moving body). Also, each of a (b_1)-st hinge 1111_1 to a (b_4)-th hinge 1114_1 can be formed at each of the (b_1)-st part 1111 to the (b_4)-th part 1114, to allow the first mode to be changed to the second mode and vice versa by operations of the first support column 1131 to the fourth support column 1134, and each one end of the first support column 1131 to the fourth support column 1134 may be connected to each of the (b_1)-st hinge 1111_1 to the (b_4)-th hinge 1114_1. For reference, ‘b’ of the (b_1)-st part 1111 to the (b_4)-th part 1114 may be an abbreviation of ‘bottom’ of the frame 1100.

Additionally, the top support 1120 of the frame 1100 is a structure configured to install at least one meteorological instrument on at least part of a top surface 1125 thereof and a front surface 1126 thereof, and each opposite end of each of the first support column 1131 to the fourth support column 1134 may be connected to each of a (t_1)-st part 1121 to a (t_4)-th part 1124 of the top support 1120. Herein, similarly to the bottom support 1110, among the (t_1)-st part 1121 to the (t_4)-th part 1124, the (t_1)-st part 1121 and the (t_2)-nd part 1122 may be located at the front direction (that is, front parts of the moving body), and the (t_3)-rd part 1123 and the (t_4)-th part 1124 may be located at the rear direction (that is, rear parts of the moving body). Also, each of a (t_1)-st hinge 1121_1 to a (t_4)-th hinge 1124_1 can be formed at each of the (t_1)-st part 1121 to the (t_4)-th part 1124 to allow the first mode to be changed to the second mode and vice versa by operations of the first support column 1131 to the fourth support column 1134, and each opposite end of the first support column 1131 to the fourth support column 1134 may be connected to each of the (t_1)-st part 1121 to the (t_4)-th part 1124 through each of the (t_1)-st hinge 1121_1 to the (t_4)-th hinge 1124_1. For reference, ‘t’ of the (t_1)-st part 1121 to the (t_4)-th part 1124 may be an abbreviation of ‘top’ of the frame 1100.

Herein, at least part of the first support column 1131 to the fourth support column 1134 can be integrated into one body. For example, the first support column 1131 and the second support column 1132 may be integrated into one body and the third support column 1133 and the fourth support column 1134 may be integrated into one body. In this case, the (t_1)-st part 1121 and the (t_2)-nd part 1122 may be the same part, and the (t_3)-rd part 1123 and the (t_4)-th part 1124 may be the same part, and accordingly, the (t_1)-st hinge 1121_1 and the (t_2)-nd hinge 1122_1 may be integrated into one body and the (t_3)-rd hinge 1123_1 and the (t_4)-th hinge 1124_1 may be integrated into one body.

Further, the first gas shock absorber 1141 and the second gas shock absorber 1142 are structures configured to support the foldable weather measurement device 1000 to be maintained in at least part of the first mode and the second mode, and one end of the first gas shock absorber 1141 may be connected to the (b_1)-st part 1111 and the opposite end thereof may be connected to a (3_1)-st part 1133_1 of the third support column 1133, and one end of the second gas shock absorber 1142 may be connected to the (b_2)-nd part 1112 and the opposite end thereof may be connected to a (4_1)-st part 1134_1 of the fourth support column 1134.

Herein, for smooth transition between the first mode and the second mode, (i) each one end of the first gas shock absorber 1141 and the second gas shock absorber 1142 may be connected to each of the (b_1)-st part 1111 and the (b_2)-nd part 1112 through each of the (b_1)-st hinge 1111_1 and the (b_2)-nd hinge 1112_1, and (ii) with a (b_1)-st sub-hinge (not shown) connected to the (b_1)-st hinge 1111_1 and a (b_2)-nd sub-hinge (not shown) connected to the (b_2)-nd hinge 1112_1 additionally formed, each one end of the first gas shock absorber 1141 and the second gas shock absorber 1142 may be connected to each of the (b_1)-st part 1111 and the (b_2)-nd part through each of the (b_1)-st sub-hinge (not shown) and the (b_2)-nd sub-hinge (not shown), but not limited thereto.

Also, in order to easily connect each of the opposite ends of the first gas shock absorber 1141 and the second gas shock absorber 1142 to each of the (3_1)-st part 1133_1 and the (4_1)-st part 1134_1, on condition that the first support column 1131 and the (3_1)-st part 1133_1 are connected via the first sub-column 1135 and the second support column 1132 and the (4_1)-st part 1134_1 are connected via the second sub-column 1136, the opposite end of the first gas shock absorber 1141 may be connected to a certain part of the first sub-column 1135 corresponding to the (3_1)-st part 1133_1, and the opposite end of the second gas shock absorber 1142 may be connected to a certain part of the second sub-column 1136 corresponding to the (4_1)-st part 1134_1. For reference, in FIG. 3A, the second sub-column 1136 is not shown due to other components blocking it, in FIG. 3B, it is shown that the second sub-column 1136 is placed symmetrically to the first sub-column 1135.

Further, the first gas shock absorber 1141 may include a first piston part 1141_1 and a first rod 1141_2, and the second gas shock absorber 1142 may include a second piston part 1142_1 and a second rod 1142_2. In the first mode, as shown in FIG. 3A, each of the first rod 1141_2 and the second rod 1142_2 maintains as being protruded from each of the first piston part 1141_1 and the second piston part 1142_2, and in the second mode, as shown in FIG. 3B, at least part of each of the first rod 1141_2 and the second rod 1142_2 maintains as being inserted into each of the first piston part 1141_1 and the second piston part 1142_1.

Specifically, as shown in FIG. 3A, in the first mode, a gas at a certain pressure is filled inside the first piston part 1141_1. Thus, the gas not only can maintain the first rod 1141_2 as being protruded out from the first piston part 1141_1, but also can maintain the first gas shock absorber 1141 and the third support column 1133 as not being moved due to the external force from the third support column 1133 to the first rod 1141_1. Likewise, by applying the same to the second gas shock absorber 1142, the second rod 1142_2 of the second gas shock absorber 1142 can be maintained as being protruded out from the second piston part 1142_1 of the second gas shock absorber 1142, but also the second gas shock absorber 1142 and the fourth support column 1134 can be maintained as not being moved.

On the other hand, as shown in FIG. 3B, in the second mode, at least part of the first rod 1141_2 having been inserted into the first piston part 1141_1 may be pushed out by the pressure of the gas remaining inside the first piston part 1141_1, thereby allowing at least part of the first rod 1141_2 to be maintained as being protruded out from the first piston part 1141_1. Likewise, by applying the same to the second gas shock absorber 1142, at least part of the second rod 1142_2 having been inserted into the second piston part 1142_1 may be pushed out by the pressure of the gas remaining inside the second piston part 1142_1, thereby allowing at least part of the second rod 1142_2 to be maintained as being protruded out from the second piston part 1142_1.

Meanwhile, the foldable weather measurement device 1000 in the first mode as shown in FIG. 3A can be explained as follows in other words:

A virtual f-th symmetric line F which connects a (f_b)-th midpoint 1116_1 of a front bottom outer side surface 1116 located in the front direction among the bottom support 1110 and a (f_t)-th midpoint 1126_1 between the (t_1)-st part 1121 and the (t_2)-nd part 1122 may be maintained at an (f_1)-st angle θ_{f_1} from a reference line M (wherein the reference line M is based on a longitudinal direction of the moving body which passes through the (f_b)-th midpoint 1116_1), and a virtual r-th symmetric line R which connects a (r_b)-th midpoint 1117_1 of a rear bottom outer side surface 1117 which is located at the rear direction among the bottom support 1110 and a (r_t)-th midpoint 1127_1 between the (t_3)-rd part 1123 and the (t_4)-th part 1124 is maintained at an (r_1)-st angle θ_{r_1} which is an angle from the reference line M (wherein the reference line M is based on the longitudinal direction of the moving body which passes through the (r_b)-th midpoint 1117_1). Herein, f means front, r means rear, and b and t each means bottom and top. For example, the (f_b)-th midpoint 1116_1 may mean midpoint at the front bottom part of the frame 1100.

However, each of the (f_b)-th midpoint 1116_1 and the (r_b)-th midpoint 1117_1 may mean each midpoint of each of the front bottom outer side surface 1116 and the rear bottom outer side surface 1117, but not limited thereto, and they may mean certain points that can be inferred from the midpoints. For example, they may be interpreted each as midpoint on the upper side of the front bottom outer side surface 1116 and a midpoint on the upper side of the rear bottom outer side surface 1117, or as shown in FIG. 3A, they may be each of the midpoint of the virtual line connecting the center of the (b_1)-st hinge 1111_1 and the (b_2)-nd hinge 1112_1 connected to each one end of the first support column 1131 and the second support column 1132 and the midpoint of the virtual line connecting the center of the (b_3)-rd hinge 1113_1 and the (b_4)-th hinge 1114_1 connected to each one end of the third support column 1133 and the fourth column 1134, or they may include all such points.

Further, as shown in FIG. 3B, the (f_2)-nd angle θ_{f_2} and the (r_2)-nd angle θ_{r_2} in the second mode can be calculated the same way as calculating the (f_1)-st angle θ_{f_1} and the (r_1)-st angle θ_{r_1} above. Also, since the (f_1)-st angle θ_{f_1} and the (r_1)-st angle θ_{r_1} are maintained as larger than the (f_2)-nd angle θ_{f_2} and the (r_2)-nd angle θ_{r_2}, this means that a height H from the main connector 1118 to the top surface 1125 of the top support 1120 in the first mode is higher than the height H′ from the main connector 1118 to the top surface 1125 of the top support 1120 in the second mode.

That is, by referring to FIG. 3A and FIG. 3B, (i) in order to change from the first mode to the second mode, at least part of the first rod 1141_2 of the first gas shock absorber 1141 is inserted into the first piston part 1141_1 of the first gas shock absorber 1141, at least part of the second rod 1142_2 of the second gas shock absorber 1142 is inserted into the second piston part 1142_1 of the second gas shock absorber 1142, and each of the first support column 1131 to the fourth support column 1134 rotates towards the front direction of the moving body through the (b_1)-st hinge 1111_1 to the (b_4)-th hinge 1114_1 and the (t_1)-st hinge 1121_1 to the (t_4)-th hinge 1114_1 until each of the first support column 1131 to the fourth support column 1134 reaches the (f_2)-nd angle θ_{f_2} or the (r_2)-nd angle θ_{r_2} respectively from the (f_1)-st angle θ_{f_1} or the (r_1)-st angle θ_{r_1}, and (ii) in order to change from the second mode to the first mode, at least part of the first rod 1141_2 of the first gas shock absorber 1141 having been inserted into the inner side of the first piston part 1141_1 is protruded from the first piston part 1141_1 due to an inner pressure thereof, at least part of the second rod 1142_2 of the second gas shock absorber 1142 having been inserted into the inner side of the second piston part 1142_1 is protruded from the second piston part 1142_1 due to an inner pressure thereof, and each of the first support column 1131 to the fourth support column 1134 rotates through the (b_1)-st hinge 1111_1 to the (b_4)-th hinge 1114_1 and the (t_1)-st hinge 1121_1 to the (t_4)-th hinge 1124_1 until each of the first support column 1131 to the fourth support column 1134 reaches the (f_1)-st angle θ_{f_1} or the (r_1)-st angle θ_{r_1} respectively from the (f_2)-nd angle θ_{f_2} or the (r_2)-nd angle θ_{r_2}. However, the (b_1)-st hinge 1111_1 to the (b_4)-th hinge 1114_1 and the (t_1)-st hinge 1121_1 to the (t_4)-th hinge 1124_1 may be at the status that may only enable the rotation of the first support column 1131 to the fourth support column 1134 each to the direction perpendicular to the ground (that is, they cannot rotate to the rear part of the moving body).

Also, (i) while the foldable weather measurement device 1000 maintains the (f_1)-st angle θ_{f_1} and the (r_1)-st angle θ_{r_1} in the first mode, the top surface 1125 of the top support 1120 is allowed to be maintained as parallel to the ground, and (ii) while the foldable weather measurement device 1000 maintains the (f_2)-nd angle θ_{f_2} and the (r_2)-nd angle θ_{r_2} in the second mode, the top surface 1125 of the top support 1120 is allowed to be maintained as parallel to the ground. Thus, even if the foldable weather measurement device 1000 changes its mode according to the driving environment of the vehicle 2000, the suitable observation conditions for each of the installed meteorological instruments mounted on the foldable weather measurement device 1000 can be secured.

Next, FIG. 4A and FIG. 4B illustrate the rear views of the foldable weather measurement device 1000 respectively operating in the first mode and the second mode in case the foldable weather measurement device 1000 further includes the antenna module 1200 and the second sub-connector module 1300.

Referring to FIG. 4A and FIG. 4B, as already explained in FIG. 3A and FIG. 3B, the antenna module 1200 can include the first sub-connector module 1210 and at least part of the first antenna 1221 and the second antenna 1222.

The first sub-connector module 1210 of the antenna module 1200 is formed in a direction perpendicular to the ground at a (b_5)-th part 1115 located at the rear direction among the bottom support 1110, and it is a structure for supporting at least part of the first antenna 1221 and the second antenna 1222 (used for transmitting and receiving of signal with outside) to be mounted in the direction perpendicular to the ground.

As one example, the (b_5)-th part 1115 may be located between the (b_3)-rd part 1113 and the (b_4)-th part, and the (b_5)-th hinge 1115_1 can be formed at the (b_5)-th part 1115 for smooth operation of the first sub-connector module 1210 in conjunction with the frame 1100 at the time of transition between the first mode and the second mode, and the lower part of the first sub-connector module 1210 can be connected to the (b_5)-th part 1115 through the (b_5)-th hinge 1115_1. Also, a pair of a first branch part 1211 and a second branch part 1212, whose one end is perpendicular to the ground, may be formed by branching laterally from the first sub-connector module 1210, and at least part of the first antenna 1221 and the second antenna 1222 can be mounted on each one end of the first branch part 1211 and the second branch part 1212.

That is, the first antenna 1221 and the second antenna 1222 are positioned as parallel to the coupling direction of the first sub-connector module 1210, and if the first sub-connector module 1210 is rotated due to a certain external force, the first antenna 1221 and the second antenna 1222 can be rotated with the same direction. For reference, the (b_5)-th hinge 1115_1 may be formed such that the first sub-connector module 1210 cannot be rotated more than 90 degrees (that is, such that it cannot be rotated to the rear direction of the moving body).

Further, referring to FIG. 4A and FIG. 4B, as already explained in FIG. 3A and FIG. 3B, the second sub-connector module 1300 can include at least part of the (2_1)-st sub-connector 1310 and the (2_2)-nd sub-connector 1220.

The (2_1)-st sub-connector 1310 is a structure whose one end is connected to a (3_2)-nd part 1133_2 of the third support column 1133 and whose opposite end is connected to a first side (i.e., the first side 1211_1 of the first branch part 1211) of the first sub-connector module 1210 where the first antenna 1211 is connected and it is a structure for moving the first antenna 1221 in conjunction with an operation of the first gas shock absorber 1141. The (2_2)-nd sub-connector 1320 is a structure whose one end is connected to a (4_2)-nd part 1134_2 of the fourth support column 1134 and whose opposite end is connected to a second side (i.e., the second side 1212_1 of the second branch part 1212) of the first sub-connector module 1210 where the second antenna 1222 is connected and it is a structure for moving the second antenna in conjunction with an operation of the second gas shock absorber.

As one example, as each of the (2_1)-st sub-connector 1310 and the (2_2)-nd sub-connector 1320, each of a (2_1)-st gas shock bar 1310 and a (2_2)-nd gas shock bar 1320 can be used. Herein, one end of a (2_1)-st sub-piston part 1311 of the (2_1)-st sub-gas shock absorber 1310 is connected to the (3_2)-nd part 1133_2 of the third support column 1133, and one end of a (2_1)-st sub-rod 1312 of the (2_1)-st sub-gas shock absorber 1310 is connected to the first side (i.e., the first side 1211_1 of the first branch part 1211) of the first sub-connector module 1210. Further, one end of a (2_2)-nd sub-piston part 1321 of the (2_2)-nd sub-gas shock absorber 1320 is connected to the (4_2)-nd part 1134_2 of the fourth support column 1134, and one end of a (2_2)-nd sub-rod 1322 of the (2_2)-nd sub-gas shock absorber 1320 is connected to the second side (i.e., the second side 1212_1 of the second branch part 1212) of the first sub-connector module 1210.

Additionally, each of the (2_1)-st sub-connector 1310 and the (2_2)-nd sub-connector 1320 can further include a (2_1)-st sub-spring 1313 and a (2_2)-nd sub-spring 1323. Specifically, the (2_1)-st sub-spring 1313 surrounds at least part of the (2_1)-st sub-piston part 1311 and the (2_1)-st sub-rod 1312, and one end of the (2_1)-st sub-spring 1313 is connected to the first side (i.e., the first side 1211_1 of the first branch part 1211) of the first sub-connector module 1210. Further, the (2_2)-nd sub-spring 1323 surrounds at least part of the (2_2)-nd sub-piston part 1321 and the (2_2)-nd sub-rod 1322, and one end of the (2_2)-nd sub-spring 1323 is connected to the second side (i.e., the second side 1212_1 of the second branch part 1212) of the first sub-connector module 1210. For reference, in order to connect each of the (2_1)-st sub-spring 1313 and the (2_2)-nd sub-spring 1323 to each of the first side 1211_1 and the second side 1212_1 of the first branch part 1211 and the second branch part 1212 of the first sub-connector module 1210, each of coupling parts 1314, 1324 may be connected to each one end of the (2_1)-st sub-spring 1313 and the (2_2)-nd sub-spring 1323, and each of the coupling parts 1314, 1324 may be connected to each of the first side 1211_1 and the second side 1212_1 of the first branch part 1211 and the second branch part 1212 of the first sub-connector module 1210 as shown in FIG. 4A and FIG. 4B, but it is not limited thereto.

Meanwhile, (i) in case of the (2_1)-st sub-connector 1310, since the length L1 from the (3_2)-nd part 1133_2 of the third support column 1133 to the first side 1213 of the first sub-connector module 1210 in the first mode as shown in FIG. 4A is shorter than the length L1′ from the (3_2)-nd part 1133_2 of the third support column 1133 to the first side 1213 of the first sub-connector module 1210 in the second mode as shown in FIG. 4B, the (2_1)-st sub-gas shock absorber whose length can be changed when changing from the first mode to the second mode or from the second mode to the first mode may be used as the (2_1)-st sub-connector 1310, and (ii) in case of (2_2)-nd sub-connector 1320, since the length L2 from the (4_2)-nd part 1134_2 of the fourth support column 1134 to the second side 1214 of the first sub-connector module 1210 in the first mode as shown in FIG. 4A is shorter than the length L2′ from the (4_2)-nd part 1134_2 of the fourth support column 1134 to the second side 1214 of the first sub-connector module 1210 in the second mode as shown in FIG. 4B, the (2_2)-nd sub-gas shock absorber whose length can be changed when changing from the first mode to the second mode or from the second mode to the first mode may be used as the (2_2)-nd sub-connector 1320.

Also, in the first mode as shown in FIG. 4A, at least part of the (2_1)-st sub-rod 1312 can be maintained as inserted in the (2_1)-st sub-piston part 1311 of the (2_1)-st sub-gas shock absorber 1310. This is because the length L1 from the (3_2)-nd part 1133_2 of the third support column 1133 to the first side 1213 of the first sub-connector module 1210 in the first mode is shorter than the length L1′ from the (3_2)-nd part 1133_2 of the third support column 1133 to the first side 1213 of the first sub-connector module 1210 in the second mode and because the (b_5)-th hinge 1115_1 cannot be rotated toward the rear direction of the moving body, which results in a higher pressure to the (2_1)-st sub-rod 1312, and the (2_1)-st sub-rod 1312 can be inserted into the (2_1)-st sub-piston part 1311 as much as the difference between L1′ and L1. Further, the first antenna 1221 can be maintained in a fixed state through the (2_1)-st sub-rod 1312 such that it maintains a direction perpendicular to the ground by the internal gas pressure of the (2_1)-st sub-piston part 1311.

Likewise, since the (2_2)-nd sub-connector 1320 is in the same state as the (2_1)-st sub-connector 1310, the (2_2)-nd sub-rod 1322 of the (2_2)-nd sub-connector 1320 can be inserted into the (2_2)-nd sub-piston part 1321 as much as the difference between L2′ and L2, and the second antenna 1222 can be maintained in a fixed state through the (2_2)-nd sub-rod 1322 such that it maintains a direction perpendicular to the ground by the internal gas pressure of the (2_2)-nd sub-piston part 1321.

On the other hand, since L1′ in the second mode is longer than L1 in the first mode and L2′ in the second mode is longer than L2 in the first mode, each pressure applied to each of the (2_1)-st sub-rod 1312 and the (2_2)-nd sub-rod 1322 due to at least part of the first antenna 1211 and the second antenna 1222 is smaller than each pressure in the first mode. Thus, at least part of the (2_1)-st sub-rod 1312 and at least part of the (2_2)-nd sub-rod 1322 inserted into each of the (2_1)-st sub-piston part 1311 and the (2_2)-nd sub-piston part 1321 is protruded from each of the (2_1)-st sub-piston part 1311 and the (2_2)-nd sub-piston part 1321 due to each inner pressure of each of the (2_1)-st sub-piston part 1311 and the (2_2)-nd sub-piston part 1321.

However, in case of using the (2_1)-st sub-gas shock absorber 1310 and the (2_2)-nd sub-gas shock absorber 1320 as each of the (2_1)-st sub-connector 1310 and the (2_2)-nd sub-connector 1320, there is a possibility that at least part of the (2_1)-st sub-gas shock absorber 1310 and the (2_2)-nd sub-gas shock absorber 1320 may fail due to the vibration generated during the driving of the moving body (such as vehicle) where the foldable weather measurement device 1000 is mounted, and due to this, there is a possibility that at least part of the (2_1)-st sub-gas shock absorber 1310 and the (2_2)-nd sub-gas shock absorber 1320 may not be able to maintain a direction perpendicular to the ground for at least part of the first antenna 1221 and the second antenna 1222 in the first mode as shown in FIG. 4A. Thus, by adding each of the (2_1)-st sub-spring 1313 and the (2_2)-nd sub spring 1323 and implementing each as the (2_1)-st spring shock absorber and the (2_2)-nd spring shock absorber, the smooth transition between the first mode and the second can be achieved, and the structural problem in the first mode can be solved.

For example, if each of the (2_1)-st sub-spring 1313 and the (2_2)-nd sub spring 1323 is added to the (2_1)-st sub-connector 1310 and the (2_2)-nd sub-connector 1320, in the first mode as shown in FIG. 4A, the (2_1)-st sub-spring 1313 shrinks by the difference between L1′ and L1 due to a pressure applied to the (2_1)-st sub-spring 1313, resulting in an insertion of at least part (i.e., a part corresponding to the difference between L1′ and L1) of the (2_1)-st sub-rod 1312 into the (2_1)-st sub-piston part 1311. Likewise, the (2_2)-nd sub-spring 1323 shrinks by the difference between L2′ and L2 due to a pressure applied to the (2_2)-nd sub-spring 1323, resulting in an insertion of at least part (i.e., a part corresponding to the difference between L2′ and L2) of the (2_2)-nd sub-rod 1322 into the (2_2)-nd sub-piston part 1311.

On the other hand, in the second mode as shown in FIG. 4B, as the pressure applied to the (2_1)-st sub-spring 1313 is relieved, the (2_1)-st sub-spring 1313 expands comparing to the (2_1)-st sub-spring 1313 at the first mode, resulting in maintaining a protrusion of at least part (i.e., a part corresponding to the difference between L1′ and L1) of the (2_1)-st sub-rod 1312 inserted in the (2_1)-st sub-piston part 1311. Likewise, as the pressure applied to the (2_2)-nd sub-spring 1323 is relieved in the second mode, the (2_2)-nd sub-spring 1323 expands comparing to the (2_2)-nd sub-spring 1323 at the first mode, resulting in maintaining a protrusion of at least part (i.e., a part corresponding to the difference between L2′ and L2) of the (2_2)-nd sub-rod 1322 inserted in the (2_2)-nd sub-piston part 1321.

That is, (i) in order to change from the first mode to the second mode, in response to a rotation of each of the first support column 1131 to the fourth support column 1134 towards the front direction of the moving body through the (b_1)-st hinge 1111_1 to the (b_4)-th hinge 1114_1 and the (t_1)-st hinge 1121_1 to the (t_4)-th hinge 1124_1, the first sub-connector module 1210 rotates towards the front direction of the moving body in conjunction with at least part of the (2_1)-st sub-connector 1310 and the (2_2)-nd sub-connector 1320 through the (b_5)-th hinge 1115_1, resulting in a rotation of at least part of the first antenna 1221 and the second antenna 1222 towards the front direction of vehicle 2000, and (ii) in order to change from the second mode to the first mode, in response to a rotation of each of the first support column 1131 to the fourth support column 1134 towards the opposite direction of the direction when the mode changes from the first mode to the second mode through the (b_1)-st hinge 1111_1 to the (b_4)-th hinge 1114_1 and the (t_1)-st hinge 1121_1 to the (t_4)-th hinge 1124_1, the first sub-connector module 1210 rotates towards the opposite direction of the direction when the mode changes from the first mode to the second mode in conjunction with at least part of the (2_1)-st sub-connector 1310 and the (2_2)-nd sub-connector 1320 through the (b_5)-th hinge 1115_1, resulting in a rotation of at least part of the first antenna 1221 and the second antenna 1222 towards the opposite direction which is opposite to a direction when the mode changes from the first mode to the second mode.

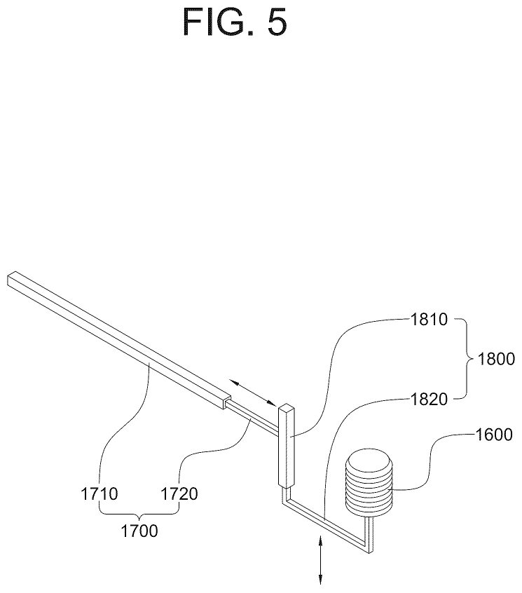

Meanwhile, referring to FIG. 3A and FIG. 3B, the foldable weather measurement device 1000 can further comprise, as the meteorological instruments for the weather observation, a wind anemometer 1400 installed in a front area among the top surface 1125 of the top support 1120 to measure a direction and a speed of wind in real time, a barometer 1500 installed on the front surface 1126 of the top support 1120 to measure an atmospheric pressure in real time, and a shading box 1600 which blocks light from the outside and has a thermometer and a hygrometer inside to measure temperature and humidity in real time, and also, depending on the meteorological phenomenon to be measured, other types of meteorological instruments may be installed on areas where the observation conditions are maintained on the frame 1100. For reference, a configuration for adjusting the position of the shading box 1600 to maintain the observation condition by connecting the shading box 1600 to the frame 1100 through a horizontal moving part 1700 and a vertical moving part 1800 will be described in detail below by referring to FIG. 5.

Referring to FIG. 5, the foldable weather measurement device comprises the horizontal moving part 1700 which moves the shading box 1600 horizontally, and the horizontal moving part 1700 may include (i) a first hollow rod part 1710 formed on at least part of the front bottom outer side surface 1116 and the rear bottom outer side surface 1117 of the bottom support 1110 as shown in FIG. 3A, and (ii) a horizontal moving column 1720 capable of being inserted or protruded through the first hollow rod part 1710. For reference, in FIG. 3A, the first hollow rod part 1710 is formed on the front bottom outer side surface 1116 of the bottom support 1110 and the horizontal moving column 1720 is shown to move to left direction of the moving body. However, since the shading box 1600 would be at the sides of the moving body in order to maintain a suitable observation condition, the horizontal moving column 1720 can be located to move to a right direction of the moving body, and the first hollow rod part 1710 can be formed at the rear bottom outer side surface 1117.

Also, a third gas shock absorber (not shown) can be formed inside the first hollow rod part 1710, and one end of the third gas shock absorber (not shown) can be connected to the horizontal moving column 1720, and the horizontal moving column 1720 can move horizontally in conjunction with an operation of the third gas shock absorber.

As an example, (i) if a signal for preventing radiant heat (generated by direct sunlight hitting the moving object) from being absorbed by the shading box 1600 is applied to measure a temperature and a humidity, the horizontal moving column 1720 moves horizontally according to the operation of the third gas shock absorber (not shown) and thus it is protruded out of the first hollow rod part 1710 until the shortest distance from the shading box 1600 to the side of the moving object becomes approximately 1m, and (ii) if a signal for preventing a safety problem due to the shading box 1600 protruding from the side of the moving body is applied when the moving body is driving, the horizontal moving column 1720 moves horizontally according to the operation of the third gas shock absorber (not shown) and thus it is inserted into the first hollow rod part 1710.

For reference, such a horizontal moving of the shading box 1600 may be automatically performed by applying the a signal through a manipulation such as pressing a button using a specific terminal. However, if an automatic operation of the horizontal moving part 1700 is unable due to a failure of some part of the foldable weather measurement device 1000, the user can manually adjust the horizontal position of the horizontal moving part 1700.

Also, the foldable weather measurement device 1000 may comprise the vertical moving part 1800 which moves the shading box 1600 vertically, and the vertical moving part 1800 may include (i) a second hollow rod part 1810 formed at one end of the horizontal moving part 1700 in a direction perpendicular to the ground and (ii) a vertical moving column 1820 capable of being inserted or protruded in a direction perpendicular to the ground through the second hollow rod part 1810. Further, the shading box 1600 may be directly or indirectly coupled to the vertical moving part 1800. For example, as shown in FIG. 5, the vertical moving column 1820 may be directly connected to the bottom of the shading box 1600, a coupling part (not shown) may be further formed at the bottom of the shading box 1600, and the vertical moving column 1820 may be indirectly connected by connecting to the coupling part (not shown).

So, the height of the shading box 1600 can be maintained at between 1.2 m to 1.5 m from the ground, which is an appropriate height according to the ground-based meteorological observation guidelines published by the Korea Meteorological Administration, by manually operating the vertical moving column 1820 of the vertical moving part 1800, but for convenient operation of the vertical movement of the shading box 1600, the height of the shading box 1600 may be adjusted automatically by applying a signal through a manipulation such as pressing a button using a specific terminal. Herein, in order to adjust the height of the shading box 1600 automatically, a fourth gas shock absorber (not shown) can be formed in the second hollow rod part 1810, one end of the fourth gas shock absorber (not shown) may be connected to the vertical moving column 1820, and the vertical moving column 1820 can move vertically in conjunction with an operation of the fourth gas shock absorber (not shown).

As an example, (i) if a signal for lowering the height of the shading box 1600 is applied, the vertical moving column 1820 may vertically move to protrude from the second hollow rod part 1810 according to the operation of the fourth gas shock absorber (not shown), and (ii) if a signal for increasing the height of the shading box 1600 is applied, the vertical moving column 1820 may vertically move into the second hollow rod part 1810 according to the operation of the fourth gas shock absorber (not shown)

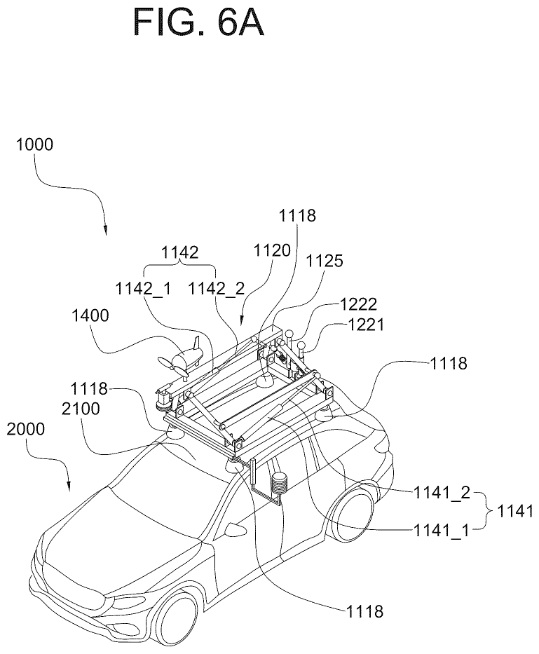

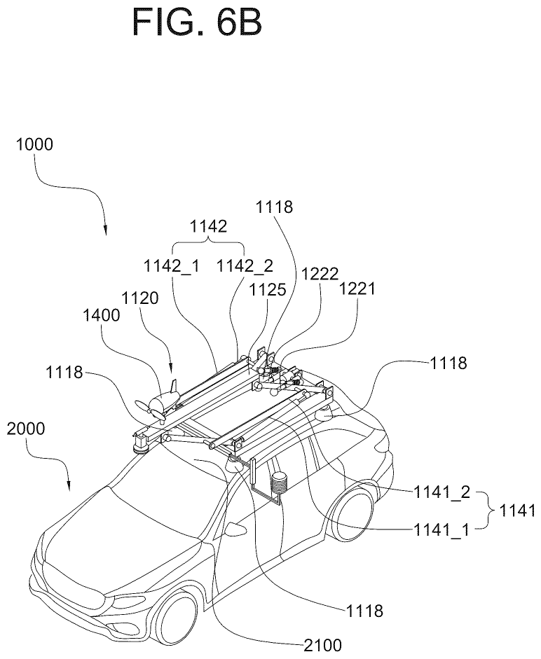

Now, an example of the foldable weather measurement device 1000 mounted on the moving body will be described by referring to FIG. 6A and FIG. 6B.

FIG. 6A illustrates the foldable weather measurement device 1000 operating in the first mode mounted on the moving body, and FIG. 6B illustrates the foldable weather measurement device 1000 operating in the second mode mounted on the moving body.

Referring to FIG. 6A and FIG. 6B, four main connectors 1118 are formed at the bottom of the bottom support 1110, and each of the four main connector 1118 is mounted on a roof 2100 of the vehicle 2000.

Herein, the foldable weather measurement device 1000 can operate in either of the first mode and the second mode according to the driving environment of the vehicle 2000, the explanation will be given assuming that the foldable weather measuring device 1000 is operating in the first mode as the default mode for convenience.

Firstly, when the foldable weather measurement device 1000 is mounted on the moving body and operating in the first mode, it can detect whether a limited height structure is within a forward threshold distance.

As an example, by using a camera module mounted on the vehicle 2000 driving in order to observe meteorological phenomenon occurring locally and for a short period of time, it is checked whether if there is any structure within the forward threshold distance having a passage height lower than (i) a summed height acquired by adding a height of from the ground to a top surface 1125 of the top support 1120 and a length which is a height of a highest meteorological instrument itself among the at least one meteorological instrument installed on the top surface 1125 of the top support 1120 or (ii) a spare summed height which is an addition of a spare height to the summed height. Herein, said structure represents a limited height structure such as tunnels, indoor parking lot, signs etc. which can crash into the foldable weather measurement device 1000. If it is determined that the limited height structure exists within the forward threshold distance, it is guided to the user by the communication module inside the vehicle 2000, and supports the user to operate such as pressing a button using a certain terminal to thereby allow the foldable weather measurement device 1000 to automatically be changed from the first mode to the second mode. However, if the automatic transition from the first mode to the second mode is not possible for some reason, the user can directly operate the first gas shock absorber 1141 and the second gas shock absorber 1142 to insert at least part of the first rod 1141_2 into the first piston part 1141_1 and to insert at least part of the second rod 1142_2 into the second piston part 1142_1, resulting in the transition from the first mode to the second mode.

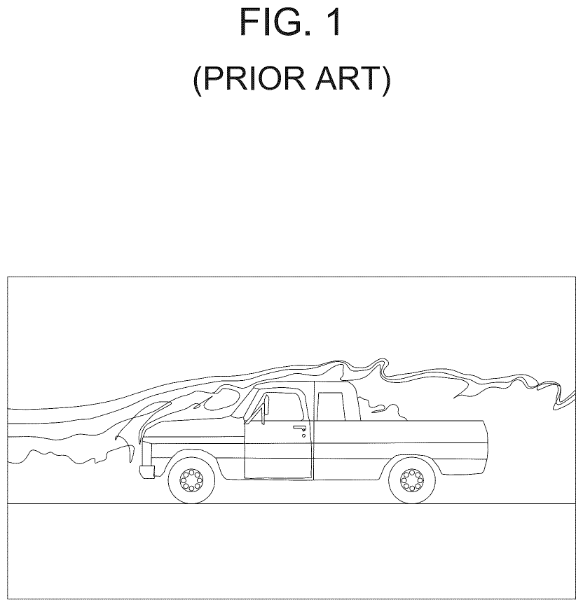

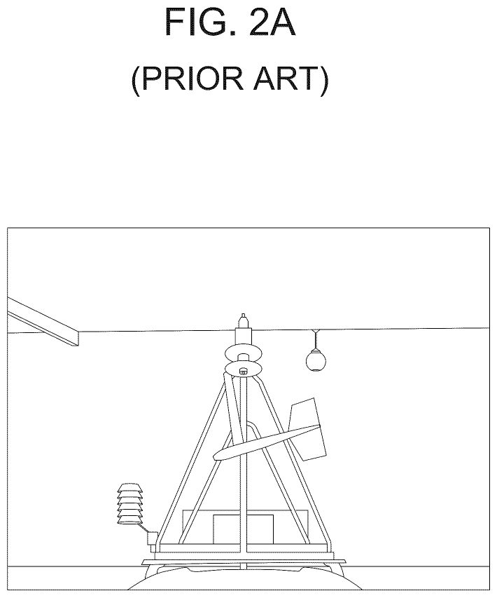

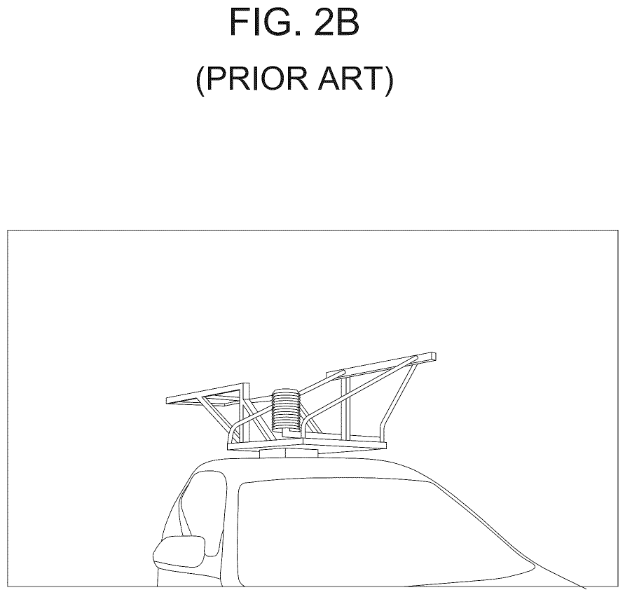

Herein, in order for the foldable weather measurement device 1000 to perform the transition from the first mode to the second mode, the anemometer 1400 should not be affected by the wind (such as vortex) as explained in FIG. 1, and thus, the height of the top surface 1125 of the top support 1125 in the second mode shown in FIG. 6B should be adjusted to be higher than a height which is easy to be affected by the wind.

At the same time, the first sub-connector module 1210 rotates towards the front direction of the vehicle 2000 in conjunction with at least part of the (2_1)-st sub-connector 1310 and the (2_2)-nd sub-connector 1320, resulting in a rotation of at least part of the first antenna 1221 and the second antenna 1222 towards the front direction of vehicle 2000.

Also, on condition that the foldable weather measurement device 1000 mounted on the vehicle 2000 is operating in the second mode as shown in FIG. 6B, when it is detected in the second mode that the vehicle 2000 has passed through a limited height structure with a passage height lower than (i) a summed height acquired by adding a height of from the ground to a top surface 1125 of the top support 1120 and a length which is a height of a highest meteorological instrument itself at a time of being operated in the first mode among the at least one meteorological instrument installed on the top surface 1125 of the top support 1120 or (ii) a spare summed height which is an addition of a spare height to the summed height, and when it is detected that no another limited height structure is within a forward threshold distance of the vehicle 2000, the first gas shock absorber 1141 and the second gas shock absorber 1142 can be operated to change from the second mode to the first mode as shown in FIG. 6A. For reference, the another limited height structure has the passage height lower than (i) the summed height acquired by adding a height of from the ground to the top surface 1125 of the top support 1120 and the length which is the height of the highest meteorological instrument itself at a time of being operated in the first mode among the at least one meteorological instrument installed on the top surface 1125 of the top support 1120, or (ii) the spare summed height which is an addition of the spare height to the summed height. Herein, the another limited height structure can be different structure from the limited height structure passed through before.

As an example, when it is detected that the foldable weather measurement device 1000 is in the second mode and the driving vehicle 2000 has passed through a limited height structure, and when it is detected that no another limited height structure is within a forward threshold distance, the driving environment is determined as safe and it is guided to the user by the communication module inside the vehicle 2000, and supports the user to operate such as pressing a button using a certain terminal to allow the foldable weather measurement device 1000 to automatically change its mode from the second mode to the first mode. However, if the automatic transition from the second mode to the first mode is not possible for some reason, the user can directly operate the first gas shock absorber 1141 and the second gas shock absorber 1142 to allow at least part of the first rod 1141_2 having been inserted into the first piston part 1141_1 to be protruded from the first piston part 1141_1 and allow at least part of the second rod 1142_2 having been inserted into the second piston part 1142_1 to be protruded from the second piston part 1142_1, resulting in the transition from the second mode to the first mode.

At the same time, the first sub-connector module 1210 rotates along the opposite direction which is opposite to a direction at a time of changing its mode from the first mode to the second mode in conjunction with at least part of the (2_1)-st sub-connector 1310 and the (2_2)-nd sub-connector 1320, resulting in a rotation of at least part of the first antenna 1221 and the second antenna 1222 along the opposite direction which is opposite to a direction at a time of changing its mode from the first mode to the second mode.

That is, the operating mode of the foldable weather measurement device 1000 should be determined as a suitable mode between the first mode and the second mode according to the driving environment of the vehicle 2000, and the position of the shading box 1600 can be adjusted by using the horizontal moving part 1700 and the vertical moving part 1800, and thus the multiple types of meteorological instruments can be mounted without interferences among one another, the breakage due to crash during the driving of the vehicle 2000 can be prevented, and suitable observation conditions for the meteorological instruments can be achieved in real time. Accordingly, the accuracy of weather observation using the foldable weather measurement device 1000 can be increased.

The present disclosure has an effect of mounting multiple types of meteorological instruments on a moving body without an interference among the multiple types of meteorological instruments, and thus to increase a suitability of observation conditions, thereby allowing accurate observation of weather.

The present disclosure has another effect of preventing breakage of the meteorological instruments by operating in a first mode or a second mode according to weather environments or driving environments of the moving body, and to maintain a suitability of the observation conditions for each of the meteorological instruments installed on the frame even during a mode switching process.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A foldable weather measurement device mounted on a moving body to observe a weather in real time, comprising:
a frame including: (i) a bottom support whose bottom part is mounted on the moving body through a main connector, (ii) a top support configured to install at least one meteorological instrument on at least part of a top surface thereof and a front surface thereof, (iii) a first support column to a fourth support column, each of which has each one end connected to each of a (b_1)-st part to a (b_4)-th part of the bottom support and each opposite end connected to each of a (t_1)-st part to a (t_4)-th part of the top support, and (iv) a first gas shock absorber and a second gas shock absorber, each of which has each one end connected to each of the (b_1)-st part and the (b_2)-nd part which are located in a front direction among the (b_1)-st part to the (b_4)-th part, and each opposite end connected to each of a (3_1)-st part of the third support column and a (4_1)-st part of the fourth support column which are located at a rear direction among the first support column to the fourth support column;
wherein the device operates in a first mode or in a second mode, wherein, when (i) the (b_1)-st part and the (b_2)-nd part are located in the front direction among the (b_1)-st part to the (b_4)-th part, (ii) the (b_3)-rd part and the (b_4)-th part are located at the rear direction among the (b_1)-st part to the (b_4)-th part, (iii) the (t_1)-st part and the (t_2)-nd part are located in the front direction among the (t_1)-st part to the (t_4)-th part, and (iv) the (t_3)-rd part and the (t_4)-th part are located at the rear direction among the (t_1)-st part to the (t_4)-th part, a virtual f-th symmetric line which connects a (f_b)-th midpoint of a front bottom outer side surface located in the front direction among the bottom support and a (f_t)-th midpoint between the (t_1)-st part and the (t_2)-nd part is maintained at an (f_1)-st angle from a reference line based on a longitudinal direction of the moving body which passes through the (f_b)-th midpoint, in the first mode, a virtual r-th symmetric line which connects a (r_b)-th midpoint of a rear bottom outer side surface which is located at the rear direction among the bottom support and a (r_t)-th midpoint between the (t_3)-rd part and the (t_4)-th part is maintained at an (r_1)-st angle which is an angle from the reference line based on the longitudinal direction of the moving body which passes through the (r_b)-th midpoint, and in the second mode, the virtual f-th symmetric line which connects the (f_b)-th midpoint of the front bottom outer side surface and the (f_t)-th midpoint is maintained at an (f_2)-nd angle which is an angle from the reference line based on the longitudinal direction of the moving body which passes through the (f_b)-th midpoint, and the virtual r-th symmetric line which connects the (r_b)-th midpoint of the rear bottom outer side surface and the (r_t)-th midpoint is maintained at an (r_2)-nd angle which is an angle from the reference line based on the longitudinal direction of the moving body which passes through the (r_b)-th midpoint, wherein the (f_1)-st angle and the (r_1)-st angle are larger than the (f_2)-nd angle and the (r_2)-nd angle,
wherein the device further comprises:
an antenna module including at least part of a first antenna and a second antenna to be used for transmitting and receiving of signal with outside, wherein the antenna module is connected to a first sub-connector module formed in a direction perpendicular to a ground at a (b_5)-th part located at the rear direction among the bottom support; and
a second sub-connector module including at least part of (i) a (2_1)-st sub-connector whose one end is connected to a (3_2)-nd part of the third support column and whose opposite end is connected to a first side of the first sub-connector module where the first antenna is connected and wherein the (2_1)-st sub-connector moves the first antenna in conjunction with an operation of the first gas shock absorber, and (ii) a (2_2)-nd sub-connector whose one end is connected to a (4_2)-nd part of the fourth support column and whose opposite end is connected to a second side of the first sub-connector module where the second antenna is connected and wherein the (2_2)-nd sub-connector moves the second antenna in conjunction with an operation of the second gas shock absorber.

2. The device according to claim 1, wherein each of a (b_1)-st hinge to a (b_4)-th hinge, a (t_1)-st hinge to a (t_4)-th hinge and a (b_5)-th hinge is formed in each of the (b_1)-st part to the (b_4)-th part, the (t_1)-st part to the (t_4)-th part and the (b_5)-th part, wherein each one end of the first support column to the fourth support column is connected to each of the (b_1)-st hinge to the (b_4)-th hinge and each opposite end of the first support column to the fourth support column is connected to each of the (t_1)-st hinge to the (t_4)-th hinge, and wherein the first sub-connector module is connected to the (b_5)-th hinge, and
(i) when a first manipulation signal for changing from the first mode to the second mode is obtained, at least part of a first rod of the first gas shock absorber is inserted into a first piston part of the first gas shock absorber, at least part of a second rod of the second gas shock absorber is inserted into a second piston part of the second gas shock absorber, and each of the first support column to the fourth support column rotates towards the front direction of the moving body until each of the first support column to the fourth support column forms the (f_2)-nd angle or the (r_2)-nd angle through the (b_1)-st hinge to the (b_4)-th hinge and the (t_1)-st hinge to the (t_4)-th hinge, and (ii) when a second manipulation signal for changing from the second mode to the first mode is obtained, at least part of the first rod inserted into the inner side of the first piston part protrudes from the first piston part due to an inner pressure thereof, at least part of the second rod inserted into the inner side of the second piston part protrudes from the second piston part due to an inner pressure thereof, and each of the first support column to the fourth support column rotates until each of the first support column to the fourth support column forms the (f_1)-st angle or the (r_1)-st angle through the (b_1)-st hinge to the (b_4)-th hinge and the (t_1)-st hinge to the (t_4)-th hinge.

3. The device according to claim 2, wherein (i) in response to a rotation of each of the first support column to the fourth support column towards the front direction of the moving body according to the first manipulation signal, the first sub-connector module rotates towards the front direction of the moving body in conjunction with the second sub-connector module through the (b_5)-th hinge, resulting in a rotation of at least part of the first antenna and the second antenna towards the front direction of the moving body, and (ii) in response to a rotation of each of the first support column to the fourth support column until it forms the (f_1)-st angle or the (r_1)-st angle according to the second manipulation signal, the first sub-connector module rotates in conjunction with the second sub-connector module through the (b_5)-th hinge, resulting in a rotation of at least part of the first antenna and the second antenna.

4. The device according to claim 1, wherein the device comprises a (2_1)-st sub-gas shock absorber as the (2_1)-st sub-connector, one end of a (2_1)-st sub-piston part of the (2_1)-st sub-gas shock absorber is connected to the (3_2)-nd part of the third support column, and one end of a (2_1)-st sub-rod of the (2_1)-st sub-gas shock absorber is connected to the first side of the first sub-connector module, and wherein the device comprises a (2_2)-nd sub-gas shock absorber as the (2_2)-nd sub-connector, one end of a (2_2)-nd sub-piston part of the (2_2)-nd sub-gas shock absorber is connected to the (4_2)-nd part of the fourth support column, and one end of a (2_2)-nd sub-rod of the (2_2)-nd sub-gas shock absorber is connected to the second side of the first sub-connector module, and
wherein (i) in the first mode, at least part of the (2_1)-st sub-rod is maintained as inserted in the (2_1)-st sub-piston part and at least part of the (2_2)-nd sub-rod is maintained as inserted in the (2_2)-nd sub-piston part, and (ii) in the second mode, at least part of the (2_1)-st sub-rod inserted in the (2_1)-st sub-piston part is maintained as protruded from the (2_1)-st sub-piston part due to an inner pressure of the (2_1)-st sub-piston part, and at least part of the (2_2)-nd sub-rod inserted in the (2_2)-nd sub-piston part is maintained as protruded from the (2_2)-nd sub-piston part due to an inner pressure of the (2_2)-nd sub-piston part.

5. The device according to claim 4, wherein the (2_1)-st sub-connector further includes a (2_1)-st sub-spring, and the (2_1)-st sub-spring surrounds at least part of the (2_1)-st sub-piston part and the (2_1)-st sub-rod, and the (2_2)-nd sub-connector further includes a (2_2)-nd sub-spring, and the (2_2)-nd sub-spring surrounds at least part of the (2_2)-nd sub-piston part and the (2_2)-nd sub-rod, and
wherein (i) in the first mode, the (2_1)-st sub-spring shrinks due to a pressure applied to the (2_1)-st sub-spring, resulting in an insertion of at least part of the (2_1)-st sub-rod into the (2_1)-st sub-piston part, and the (2_2)-nd sub-spring shrinks due to a pressure applied to the (2_2)-nd sub-spring, resulting in an insertion of at least part of the (2_2)-nd sub-rod into the (2_2)-nd sub-piston part, and (ii) in the second mode, the (2_1)-st sub-spring expands comparing to the (2_1)-st sub-spring at the first mode, resulting in a protrusion of at least part of the (2_1)-st sub-rod inserted in the (2_1)-st sub-piston part, and the (2_2)-nd sub-spring expands comparing to the (2_2)-nd sub-spring at the first mode, resulting in a protrusion of at least part of the (2_2)-nd sub-rod inserted in the (2_2)-nd sub-piston part.

6. The device according to claim 1, wherein the device further comprises:
a horizontal moving part including (i) a first hollow rod part formed in at least part of the front bottom outer side surface and the rear bottom outer side surface, and (ii) a horizontal moving column capable of being inserted or protruded through the first hollow rod part;
a vertical moving part including (i) a second hollow rod part formed at one end of the horizontal moving part, and (ii) a vertical moving column capable of being inserted or protruded through the second hollow rod part; and
a shading box directly or indirectly coupled to the vertical moving part.

7. The device according to claim 6, wherein the device further comprises: a third gas shock absorber formed in the first hollow rod part; and wherein one end of the third gas shock absorber is connected to the horizontal moving column, and the horizontal moving column moves horizontally in conjunction with an operation of the third gas shock absorber.

8. The device according to claim 7, wherein the device further comprises: a fourth gas shock absorber formed in the second hollow rod part; and wherein one end of the fourth gas shock absorber is connected to the vertical moving column, and the vertical moving column moves vertically in conjunction with an operation of the fourth gas shock absorber.

9. The device according to claim 1, wherein, while maintaining the (f_1)-st angle and the (r_1)-st angle in the first mode, a top surface of the top support is maintained as parallel to the ground, and while maintaining the (f_2)-nd angle and the (r_2)-nd angle in the second mode, the top surface of the top support is maintained as parallel to the ground.

10. The device according to claim 1, wherein, in the first mode, when a limited height structure with a passage height lower than (i) a summed height of a height of from the ground to a top surface of the top support and a length which is a height of a highest meteorological instrument itself among the at least one meteorological instrument installed on the top surface of the top support or (ii) a spare summed height which is an addition of a spare height to the summed height is detected, the first gas shock absorber and the second gas shock absorber are operated to change from the first mode to the second mode by changing from the (f_1)-st angle and the (r_1)-st angle to the (f_2)-nd angle and the (r_2)-nd angle.

11. The device according to claim 1, wherein, when it is detected in the second mode that the moving body has passed through a limited height structure with a passage height lower than (i) a summed height acquired by adding a height of from the ground to a top surface of the top support and a length which is a height of a highest meteorological instrument itself at a time of being operated in the first mode among the at least one meteorological instrument installed on the top surface of the top support or (ii) a spare summed height which is an addition of a spare height to the summed height, and when it is detected that no another limited height structure is within a forward threshold distance of the moving body, wherein said another limited height structure has the passage height lower than (i) the summed height acquired by adding a height of from ground to the top surface of the top support and the length which is the height of the highest meteorological instrument itself at a time of being operated in the first mode among the at least one meteorological instrument installed on the top surface of the top support, or (ii) the spare summed height which is an addition of the spare height to the summed height, wherein the another limited height structure is different structure from the limited height structure, the first gas shock absorber and the second gas shock absorber are operated to change to the first mode by changing from the (f_2)-nd angle and the (r_2)-nd angle to the (f_1)-st angle and the (r_1)-st angle.

12. The device according to claim 1, wherein the device further comprises:
a wind anemometer installed in a front area among the top surface of the top support to measure a direction and a speed of wind in real time.

13. The device according to claim 1, wherein the device further comprises:
a barometer installed on the front surface the top support to measure an atmospheric pressure.
